(19) United States
(12) Patent Application Publication
(10) Pub. No.: US 2016/0114849 A1
(43) Pub. Date: Apr. 28, 2016

(54) Motorcycle Lower Fork Tube Protective/Decorative Cover(s)

(71) Applicants: Michael Mingola, Hobe Sound, FL (US); Stephen O'Dell, West Palm Beach, FL (US)

(72) Inventors: Michael Mingola, Hobe Sound, FL (US); Stephen O'Dell, West Palm Beach, FL (US)

(21) Appl. No.: 14/922,014

(22) Filed: Oct. 23, 2015

Related U.S. Application Data
(60) Provisional application No. 62/068,576, filed on Oct. 24, 2014.

(51) Int. Cl. B62J 23/00

(52) U.S. Cl. CPC B62J 23/00

(57) ABSTRACT

The protective/decorative covering(s) designed, in which provides two (2) methods: 1. method of protection and 2. method of decoration, is used to protect a motorcycle's lower fork tubes against road debris and other elements, such as sand, dirt, bugs, and the like, as well as decorative use to customarily disguise the lower fork tubes thereby making them appear to be that of a different type or appearance. The protective/decorative covering is designed to produce a set of covering pieces (2), to which each cover is cut and manufactured separately and applied individually. Application of the protective/decorative covering(s) can be quickly applied, removed and/or replaced. The method for manufacturing and the method of application is disclosed.

### BACKGROUND

Damage to the lower fork tubes of a motorcycle primarily occurs from exposure to road debris and other elements, such as sand, dirt, bugs, and the like. And as a result, the lower fork tubes present a damaged appearance and may potentially incur extensive time-consuming repairs and expenses.

In the present invention, the lower fork tube protective/decorative cover(s), attributes two major benefits, protection and decoration of a motorcycle's lower fork tubes. The protective/decorative cover(s) impedes damage from road debris and other elements, such as sand, dirt, bugs, and the like, providing protection to the lower fork tubes surface and in turn, alters the appearance of the lower fork tubes.

The protective/decorative cover(s) is also utilized to provide the lower fork tubes that of a different type and appearance. This too, allows an individual an opportunity to avoid any time-consuming repairs and any expenses incurred.

As disclosed in the method of manufacture and method of application, the protective/decorative cover is designed to produce a set of covering pieces (2), to which each cover is cut and manufactured separately and applied individually.

### BRIEF SUMMARY OF INVENTION

The present invention is a protective/decorative covering used for the protection and decoration of a motorcycle lower fork tube. The invention provides protection coverage to the lower forks surface. The material in which is used to manufacture the protective/decorative covering is comprised of vinyl, leather or cloth and the application of the protective/decorative cover, as well as the removal of same, is a quick and effortless process. The securement of the protective/decorative covering relies on the “loop” and “hook” Velcro fasteners, as described in the method of application.

The present invention also offers a more customized decoration, if so desired and different makes, models and years may vary, providing ample opportunity to motorcycle owners. For example, this pattern is designed for a 2004 Harley Davidson Road King.

### BRIEF DESCRIPTION OF THE DRAWINGS

FIG. 1, 19 illustrates the lower fork tube. It is a perspective side view of a motorcycle front lower fork tube, covered with the protective/decorative covering (as shown in FIG. 1, #20);

FIG. 1, 20 illustrates the face/outside view of the protective/decorative covering, shown in the present invention and in accordance with the structural design for protection and decoration;

FIG. 1, 21 illustrates the front fender bolt mount of the lower fork tube;

FIG. 1, 22 illustrates the break caliper mount of lower fork tube;

FIG. 1, 23 illustrates the upper slide cover. The protective/decorative cover is applied underneath the upper slide cover, as described in the method of application;

FIG. 1, 27 illustrates the break rotor;

FIG. 1, 33 illustrates the front fender;

FIG. 2, 20 illustrates the face/outside view of the protective/decorative covering (as shown in FIG. 1, #20);

FIG. 2, 24 illustrates the area of material to which gets concealed up under the upper slide cover (see FIG. 1, #23) when the protective/decorative covering is applied;

FIG. 2, 25 illustrates the cutout to which keeps material from overlapping and binding, once protective/decorative covering is applied and in place under the upper slide cover (as referenced in FIG. 1, #23);

FIG. 2, 26 illustrates the cutout for the break caliper mount (see FIG. 1, #22) on the inner side of the lower fork tube, adjacent to the brake rotor (see FIG. 1, #27). FIG. 2, 26 is also known as the perimeter;

FIG. 2, 28 illustrates the cutout for the brake caliper mount (see FIG. 1, #22) on the outer side of the lower fork tube. FIG. 2, 28 is also known as the perimeter;

FIG. 2, 29 illustrates the cutout for the front fender bolt mount of the lower fork tube (see FIG. 1, #21);

FIG. 3, 20 illustrates the face/outside view of the protective/decorative covering (as shown in FIG. 1, #20 and FIG. 2, #20);

FIG. 3, 30 illustrates the “loop” Velcro fasteners, which will adhere to the “hook Velcro fasteners (see FIG. 6, #32) securing the protective/decorative cover in place on the lower fork tube;

FIG. 3, 31 illustrates the stitching, which repeats uniformly on the perimeter surfaces where shown;

FIG. 3, 34 illustrates the bottom perimeter of the protective/decorative covering;

FIG. 4 illustrates the side view of the left side of the protective/decorative covering;

FIG. 5 illustrates the top view of the protective/decorative covering;

FIG. 6, 20A illustrates the backside view of the protective/decorative covering;

FIG. 6, 31 illustrates the stitching, which repeats uniformly on the perimeter surfaces where shown;

FIG. 6, 32 illustrates the “hook” Velcro fasteners, which will adhere to the “loop” Velcro fasteners (see FIG. 3, #30), securing the protective/decorative cover in place on the lower fork tube;

FIG. 6, 35 illustrates the section of the protective/decorative covering that is inserted between the fender (see FIG. 1, #33) and the lower fork tube (see FIG. 1, #19) (For application purposes);

FIG. 7 illustrates the side view of the left side of the protective/decorative covering;

FIG. 8 illustrates the bottom view of the protective/decorative covering.

### DETAILED DESCRIPTION AND BEST MODE OF IMPLEMENTATION

The protective/decorative covering(s), as it relates to the present invention, which is comprised of vinyl, leather or cloth, is designed to protect the lower fork tubes of a motorcycle from road debris and other elements, such as sand, dirt, bugs, and the like, and in doing so provides a decorative covering, altering the look of the type and appearance of the lower fork tubes, as referenced in claims 1 and 2.

As referenced in the background of the invention, as well as claim 3, the protective/decorative cover is designed to produce a set of protective/decorative covering pieces (2), to which each cover is cut and manufactured separately and applied individually.

### Method Of Manufacturing

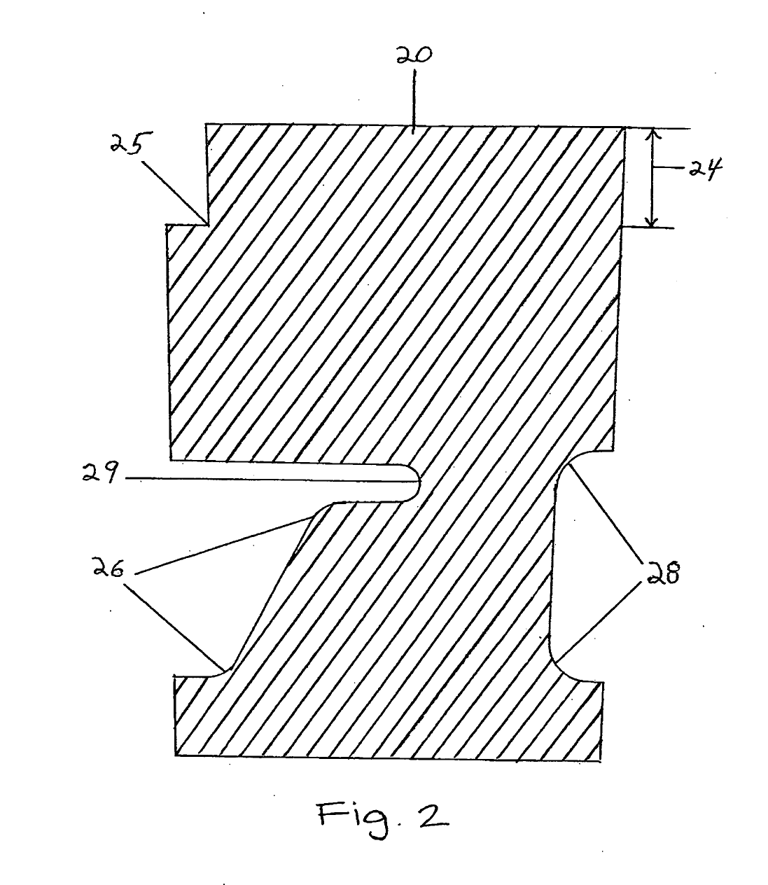

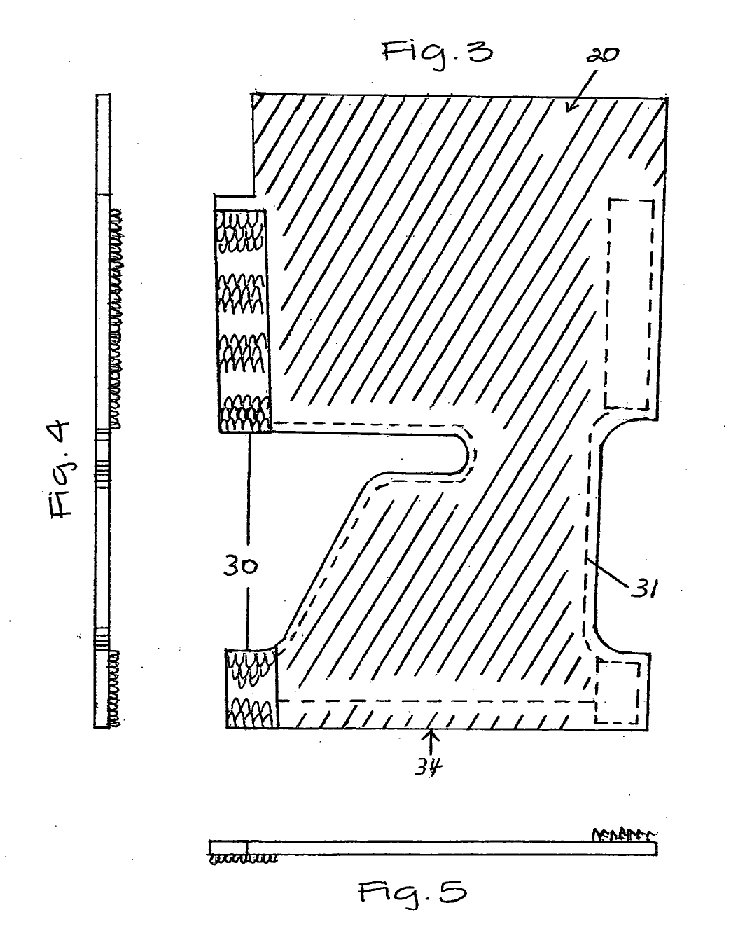

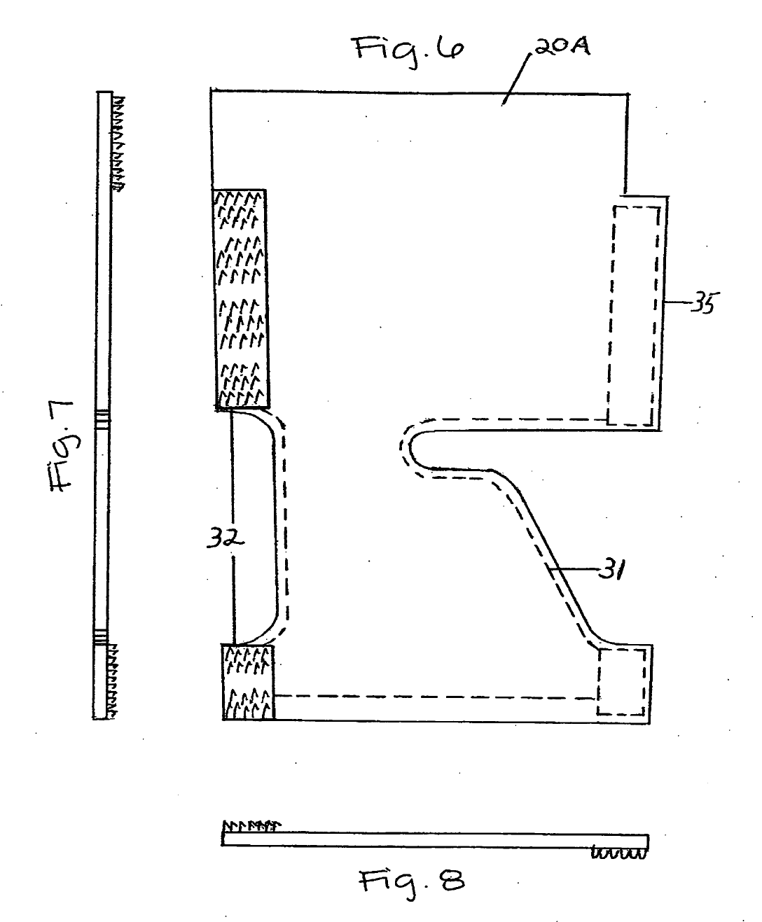

First, the material, which is comprised of vinyl, leather or cloth, is cut to the pattern of the protective/decorative covering (see #20, FIG. 2). The Velcro fasteners (see #30. FIGS. 3 and #32 FIG. 6) are cut to size and then sewn into place. Begin by stitching the first “loop” Velcro fastener (see #30, FIG. 3) to the face side of protective/decorative covering material (see #20, FIG. 2), at the upper left hand corner just beneath the cutout to which keeps the material from overlapping and binding, (see #25, FIG. 2) once applied in place. The stitch will then continue around the perimeter (see #26 and #29, FIG. 2) of the protective/decorative covering material, securing the second “loop” Velcro fastener (see #30, FIG. 3) to the lower left hand side. The stitch is continued along the bottom perimeter (see #34, FIG. 3) of the protective/decorative covering material. The stitching around the perimeters (see #26, #28, #29, FIGS. 2 and #31 and #34, FIG. 3) is to help limit stretching of the material. End stitch.

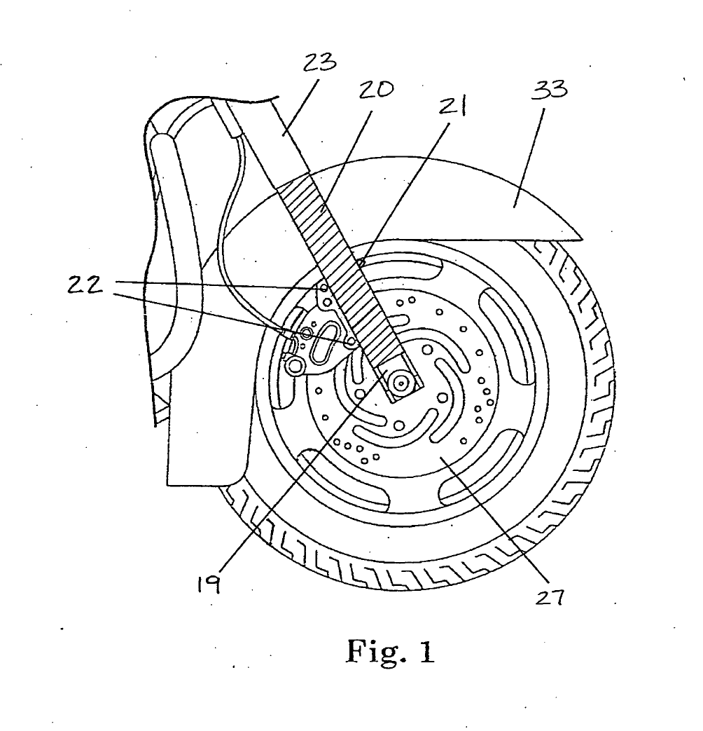

Next, the material is flipped over with the backside of the covering (see #20A, FIG. 6) facing upward. Again, the process of securing the Velcro fasteners is applied, as previously described. Begin stitching the first “hook” Velcro fastener (see #32, FIG. 6) to the backside of the protective/decorative covering material (see #20A, FIG. 6), at the upper left hand corner, just beneath the area of material (see #24, FIG. 2) to which gets concealed up under the upper slide cover (see #23, FIG. 1). Continue again, the stitching (see #31, FIG. 3 and FIG. 6) around the perimeter (see #28, FIG. 2) of the protective/decorative covering material, securing the second “hoop” Velcro fastener (see #32, FIG. 6) to the lower left hand side. The stitching around the perimeters (see #26, #28, #29, FIGS. 2 and #31, #34, FIG. 3) is to help limit stretching of the material. End stitch. The method described above, is then repeated to manufacture the second protective/decorative covering, making a complete pair.

### Method Of Application

Application of the protective/decorative covering(s) consists of very simple steps. To begin, you will take the protective/decorative covering, with the backside facing outward and insert the protective/decorative cover between the lower fork tube (see #19, FIG. 1) and the front fender (see #33, FIG. 1), meanwhile at the same time sliding the protective/decorative cover under the upper slide cover (see #23, FIG. 1). Once in place, begin wrapping the protective/decorative covering around the face of the lower fork tube, adhering the Velcro fasteners (see #30. FIGS. 3 and #32 FIG. 6) to one another securing the protective/decorative covering in place. Tighten and adjust as needed.

The method described above, is then repeated to apply the second protective/decorative covering in place.

REFERENCES CITED

| | | | | |
|---|---|---|---|---|
| 1. | D491,112 S | June 2004 | Frances et al. | |
| 2. | 6,837,508 B2 | January 2005 | Frances et al. | 280/276 |
| 3. | 4,138,132 A | February 1979 | Doyle | 280/304.3 |
| 4. | D295,396 S | April 1988 | Rudd et al. | |
| 5. | D313,774 S | January 1991 | Hauer | |
| 6. | 7,185,905 B2 | March 2007 | Czysz | 280/276 |
| 7. | D341,343 S | November 1993 | Netz | |
| 8. | D444,104 S | June 2001 | Baker | D12/126 |
| 9. | 7,637,520 B2 | December 2009 | Madden | |
| 10. | 2009/0051140 A1 | February 2009 | Saguchi | 280/304.3 |

1. In the present invention, the lower fork tube protective/decorative cover(s), attributes two major benefits, protection and decoration of a motorcycle's lower fork tubes. The protective/decorative cover(s) impedes damage from road debris and other elements, such as sand, dirt, bugs, and the like, providing protection to the lower fork tubes surface and in turn, alters the appearance of the lower fork tubes.
The method of claim 1, wherein the lower fork tube protective/decorative covering(s) protects the lower fork tubes of a motorcycle from road debris and other elements, such as sand, dirt, bugs, and the like. This in turn, allows an individual an opportunity to avoid any time-consuming repairs and any expenses incurred.
The method of claim 1, wherein the lower fork tube protective/decorative covering(s) provides a decorative method used to customarily disguise the lower fork tubes thereby making them appear to be that of a different type or appearance. This too, allows an individual an opportunity to avoid any time-consuming repairs and any expenses incurred.

2. The material in which is used to manufacture the protective/decorative covering(s) is comprised of vinyl, leather or cloth and the application of the protective/decorative cover(s), as well as the removal of same, is a quick and effortless process.
The method of claim 2, wherein the lower fork tube protective/decorative covering(s) can be quickly applied, removed and/or replaced.

3. The protective/decorative covering is designed to produce a set of covering pieces (2), to which each cover is cut and manufactured separately and applied individually.
